(19) United States
(12) Patent Application Publication
(10) Pub. No.: US 2024/0289754 A1
(43) Pub. Date: Aug. 29, 2024

(54) CRYPTO MANAGEMENT

(71) Applicant: NCR Corporation, Atlanta, GA (US)

(72) Inventors: Kip Oliver Morgan, Atlanta, GA (US); Gina Torcivia Bennett, Lawrenceville, GA (US); Wuchieh James Jong, Raleigh, NC (US); Kelli Lee, Atlanta, GA (US); Jerry Steven Massey, Lawrenceville, GA (US)

(21) Appl. No.: 18/115,323

(22) Filed: Feb. 28, 2023

(51) Int. Cl. G06Q 20/06; G06Q 20/36; G06Q 30/0226

(52) U.S. Cl. CPC G06Q 20/065; G06Q 20/36; G06Q 30/0226

(57) ABSTRACT

A consumer links a cryptocurrency wallet to their loyalty account and creates a profile that includes a default fiat currency amount to add to transaction totals during transactions at a terminals. During a transaction, the wallet and profile are obtained using the loyalty account of a registered consumer. When the consumer selects an option to pay for their transaction, an overlaid screen is presented to the consumer on the display of the terminal requesting that the consumer confirm the fiat currency amount. When the consumer confirms, the transaction total for the transaction is rounded up by the fiat currency amount. A background workflow is automatically initiated after payment is confirmed on behalf of the user. The workflow uses the fiat currency amount to purchase and transfer an equivalent amount of cryptocurrency into the consumer's wallet over the blockchain.

### BACKGROUND

Saving money can be hard and usually people do not save enough. Research indicates fewer than 4 in 10 people have enough to pay for an unexpected $1,000 expense in cash. Transferring money to savings accounts monthly is tedious and easily forgotten. Sending money to traditional bank accounts is usually not a simple process.

Savings amounts often are not visible during day-to-day transactions, leaving consumers unaware of the money they have. Many shoppers have a personal incentive or need for their savings to be private, often times, however, money is closely monitored by family members or partners. Automated Teller Machines (ATMs) that support cryptocurrency transactions are not inherently user friendly. Self-checkouts and point-of-sale (POS) terminals currently require a separate transaction to handle cryptocurrency if the checkouts/terminals support cryptocurrency at all.

### SUMMARY

In various embodiments, methods and a system for cryptocurrency asset management are presented. Consumers can register and link their cryptocurrency wallets with their loyalty accounts. A consumer also maintains a profile indicating a default fiat currency amount to roundup a transaction total during a transaction at a terminal. During a transaction, the loyalty account of a consumer is linked to the consumer's wallet address and the consumer's profile is obtained. When the consumer selects payment to pay for the transaction, the consumer is asked to confirm the roundup fiat currency amount and when confirmed the transaction total is rounded up by the fiat currency amount. The consumer then pays for the transaction, which initiates a background workflow that uses the fiat currency amount, purchases an equivalent amount of cryptocurrency, and automatically transfers the cryptocurrency over the blockchain directly into the consumer's wallet.

### BRIEF DESCRIPTION OF THE DRAWINGS

FIG. 1A is a diagram of a system for cryptocurrency asset management, according to an example embodiment.

FIG. 1B is a diagram depicting a registration workflow for registering for cryptocurrency asset management and an example screen rendered for a portion of the registration on a user-operated device, according to an example embodiment.

FIG. 1C is a diagram of another sample screen rendered on a user-operated device during registration, according to an example embodiment.

FIG. 1D illustrates sample screens rendered on a transaction terminal during a transaction of a registered user, according to an example embodiment.

FIG. 1E is illustrates sample screens rendered on the transaction terminal during a transaction, according to an example embodiment.

FIG. 1F is a diagram of a workflow for registering and using the cryptocurrency asset management during a transaction, according to an example embodiment.

FIG. 2 is a flow diagram of a method for cryptocurrency savings during a transaction of a user, according to an example embodiment.

FIG. 3 is a flow diagram of another method for cryptocurrency savings during a transaction of a user, according to an example embodiment.

### DETAILED DESCRIPTION

As stated above, a majority of consumers are not in the habit of saving and saving options are not convenient nor intuitive. It is also known that sending money to crypto wallets can be anonymous and discrete, many consumers are concerned about their privacy when saving. “Ransomware” requests are often requested in cryptocurrency for anonymity. In fact, most cryptocurrencies provide far greater anonymity and privacy during transactions than does conventional fiat-based transactions.

The techniques presented herein and below improves the technique by which a consumer can save a desired amount of cryptocurrency during each consumer's fiat-based transaction at a transaction terminal; funded by the consumer with fiat currency used as transaction payment for the transaction. A consumer registers and links a cryptocurrency wallet to their retailer-based loyalty account and designates a specific amount/percentage of fiat currency to add to their transaction total for savings as cryptocurrency in the consumer's wallet. During a transaction of the consumer, the consumer is asked to confirm the amount/percentage of cryptocurrency purchase into their wallet when the user selects payment on the transaction terminal to complete the transaction. Once confirmed, the transaction total price is discretely increased by the savings amount, the consumer pays, and the fiat currency amount is used to purchase the cryptocurrency into the consumer's wallet over the blockchain. In an embodiment, the terminal produces two separate receipts one with no indication of the consumer's savings and one with the savings noted for added privacy to the consumer. Furthermore, minimal enhancements are needed to the existing transaction workflows on the terminals to implement the consumer's savings.

As used herein, a “fiat currency” is a government backed currency, such as U.S. dollars, European Euros, Mexican Pesos, Brazilian Reals, etc. A “cryptocurrency” includes different types, such as Bitcoin® (BTC), Ethereum® (ETH), Dodgecoin® (Dodge), etc.

The terms “consumer,” “customer,” “shopper,” and/or “user” may be used synonymously and interchangeable herein. This is an individual who is saving cryptocurrency during transactions performed by the user at a transaction terminal.

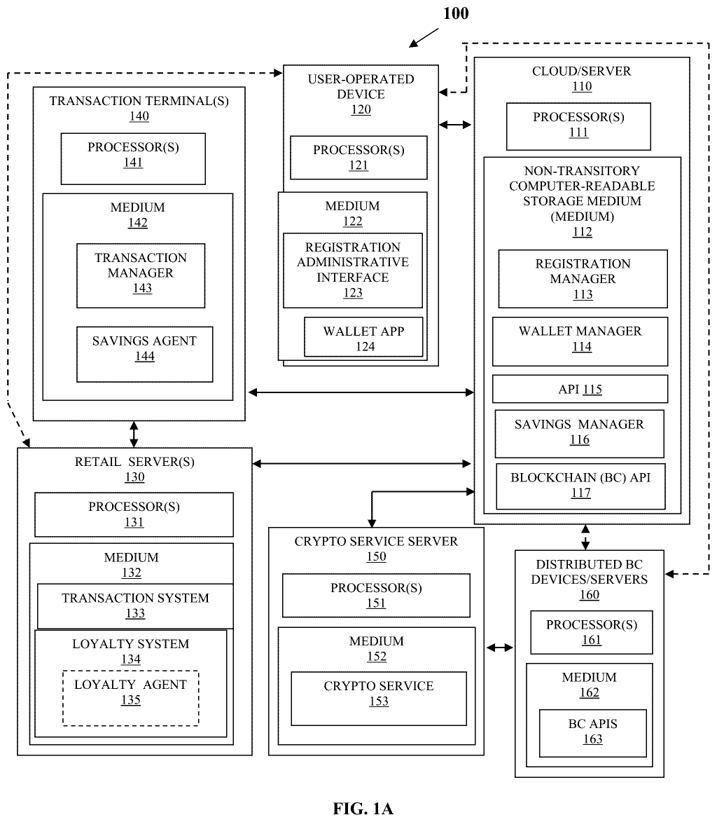

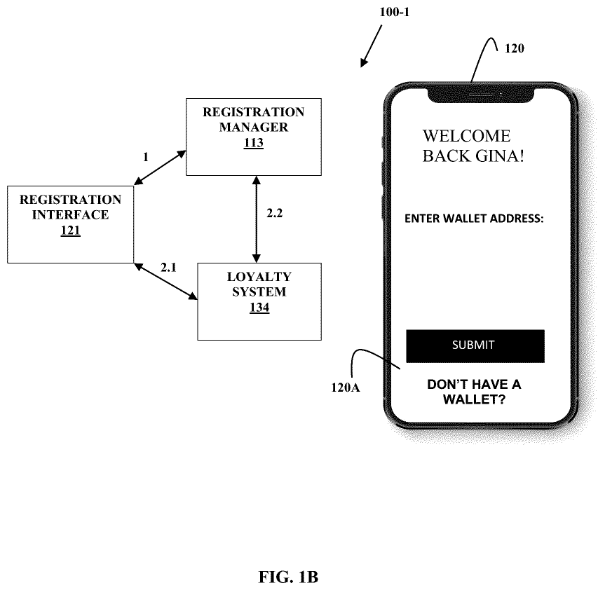

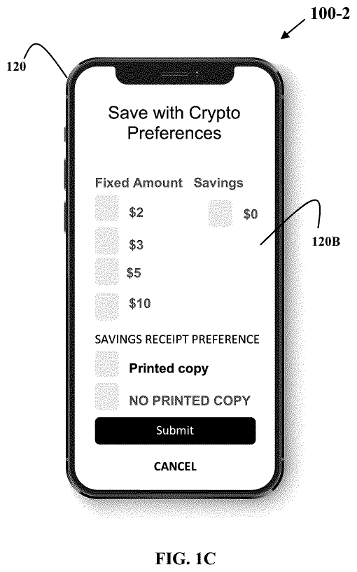

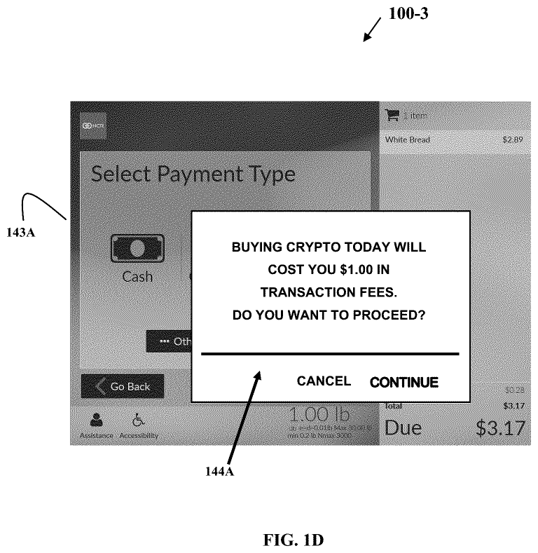

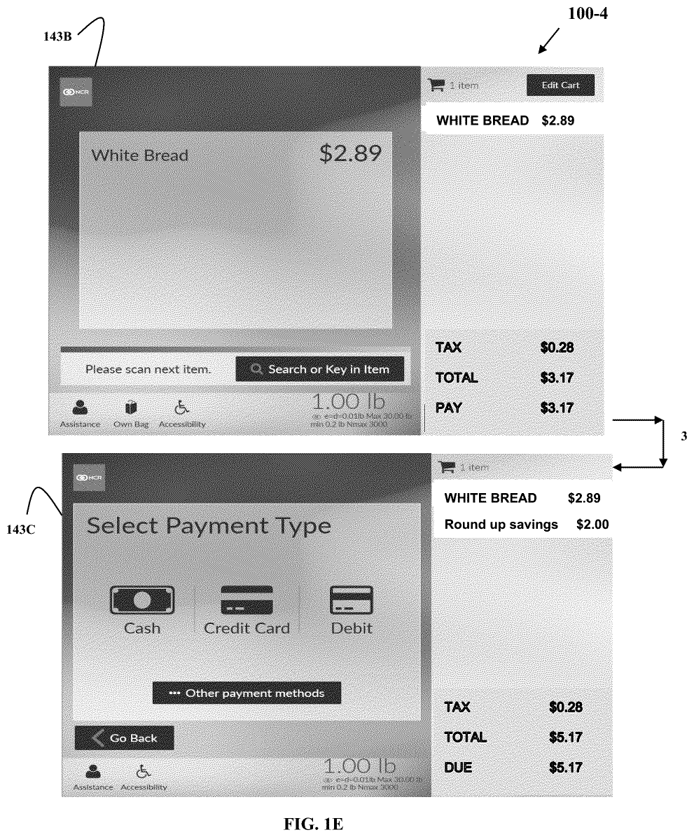

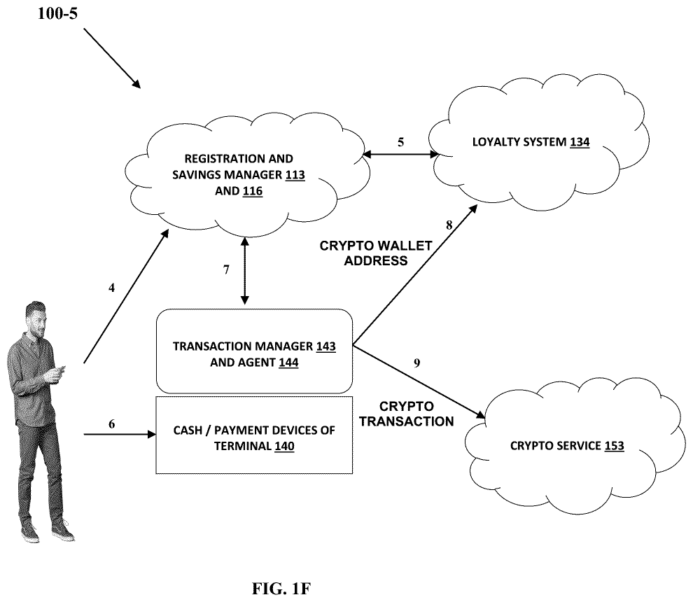

FIG. 1A is a diagram of a system 100 for cryptocurrency asset management, according to an example embodiment. The system 100 is shown schematically in greatly simplified form, with only those components relevant to understanding of one or more embodiments (represented herein) being illustrated. The various components are illustrated, and the arrangement of the components are presented for purposes of illustration only. It is to be noted that other arrangements with more or less components are possible without departing from cryptocurrency asset management techniques presented herein and below.

Moreover, various components are implemented as one or more software modules, which reside in non-transitory storage and/or hardware memory as executable instructions that when executed by one or more hardware processors perform the processing discussed herein and below.

System 100 includes a cloud 110 or a server 110 (hereinafter just “cloud 110”), user operated device(s) 120, retail server(s) 130, transaction terminals 140, a crypto service server 150, and distributed blockchain (BC) devices/servers 160. Cloud 110 includes one or more processors 111 and a non-transitory computer-readable storage medium 112 (herein after just “medium”), which includes instructions for a registration manager 113, a wallet manager 114, an application programming interface (API) 115, a savings manager 116, and a BC API 117. The instructions when provided to processor 111 cause processor 111 to perform operations discussed herein and below with respect to 113-117.

Each user device 120 includes a processor 121 and medium 122, which includes instructions for a registration interface 123 and a wallet application (hereinafter just “app”) 124. The instructions when provided to processor 121 cause processor 121 to perform operations discussed herein and below with respect to 123-124.

Each retail server 130 includes a processor 131 and medium 132, which includes instructions for a transaction system 133 and a loyalty system 134. Optionally, loyalty system 134 includes instructions for a loyalty agent 135. The instructions when provided to processor 131 cause processor 131 to perform operations discussed herein and below with respect to 133-135.

Each transaction terminal 140 includes one or more processors 141 and medium 142, which includes instructions for transaction manager 143 and savings agent 144. The instructions when provided to processor 141 cause processor 141 to perform operations discussed herein and below with respect to 143-144.

Crypto service server 150 includes one or more processors 151 and medium 152, which includes instructions for crypto service 153. The instructions when provided to processor 151 cause processor 151 to perform operations discussed herein and below with respect to 153.

Each distributed BC device/server 160 includes one or more processors 161 and medium 162, which includes instructions for BC APIs 162. The instructions when provided to processor 161 cause processor 161 to perform operations discussed herein and below with respect to 163. BC devices/servers 160 maintain the BC.

System 100 can process a variety of workflows some of which are now discussed. Other workflows not discussed are intended to fall within the scope of the teachings presented here.

Initially, a user/consumer (hereinafter just “user”) registers for taking advantage of a retailer's loyalty program through services provided by cloud 110. During registration, the user provides a loyalty account identifier through registration interface 123 to registration manager 113 along with a wallet identifier for a cryptocurrency (hereinafter just “crypto”) wallet associated with the user's wallet app 124. It is noted that the user interface of registration interface 123 permits a user within an existing wallet to create a wallet and download wallet app 124 to user device 120. After linking the user's loyalty account and wallet (via a wallet identifier), the registration manager 113 renders a variety of other options to the user for the user to establish preferences or a profile. For example, the user may be asked which type of crypto the user desires to purchase during fiat transactions. The user is also asked what the default amount of fiat currency is to be set to. The amount can be set as a percentage of a user's transaction total or set as a fixed fiat currency amount. Furthermore, the user is asked how a receipt for the savings during a transaction is to be handled. For example, the user can select no printed receipt for the savings or a separately printed receipt, which is separate from the transaction receipt of the transaction. Registration manager 113 records the selections of the user and creates a profile for the user associated with the loyalty account, such that when the user performs a transaction and uses the loyalty account, the user is asked on the terminal 140 of the transaction whether the user desires to add the fiat amount set by the user to the transaction total and purchase an equivalent amount of crypto in the user preferred crypto type into the user's crypto wallet. In an embodiment, the user may also make selections for the profile but then elected to turn off the savings feature, such that the user has savings preferences noted but the savings itself is not activated, this turn on and off feature is discussed below with reference to FIG. 1C and screen 120B.

It is to be noted that registration interface 123 can also be an administrative interface 123, which permits the user to change registration options/selections whenever the user elects to do so. For instance, the user can desire to temporarily shut down the crypto savings for a user-desired period of time, administrative interface permits the user to interact with registration manager 113 and change previously set options in the user's profile.

After registration, the user performs a checkout at a transaction terminal 140. The transaction is processed by transaction manager 143 through a transaction interface that renders transaction screens on a display of the terminal 140 for receiving user input. Savings agent 144 monitors the state of the transaction to determined when the user has selected the payment option to being payment for the user's goods. Transaction manager 143 is enhanced to provide any loyalty account identified for the user during the transaction.

Agent 144 sends the loyalty account to savings manager 116, savings manager 114 interacts with wallet manager 114 to obtain a crypto wallet identifier that is linked to the loyalty account of the user. Savings manager 116 returns the user's profile/preferences and wallet identifier to agent 144. In an embodiment, manager 116 also provides agent the current fee associated with purchasing crypto on the blockchain (hereinafter just “BC”).

When agent 144 determines that the user selected payment indicating the transaction interface has rendered the types of payments available screen for payment to the user on the display of terminal 140, agent 144 uses the profile to overlay a screen on top of the transaction interface screen for payment types to ask the user to confirm that the user wants to add the preferred fiat amount to the transaction total for purposes of purchasing crypto into the user's registered wallet. The overlaid screen can also notify the user about the current fee associated with purchasing the crypto from the blockchain (BC). In an embodiment, the agent 144 provides an option in the overlaid screen for the user to change the user's set default fiat amount for the savings to a override fiat amount entered by the user into the overlaid screen.

Assuming, the user confirmed the desire to add a user-default or user-override amount of fiat currency to the transaction total for the transaction, agent 144 notifies transaction manager 143 to add the fiat currency amount and BC fee to the transaction total for the transaction. Agent 144 also sends the wallet identifier and the fiat currency amount back to manager 116. Optionally, agent 144 sends a transaction identifier for the transaction, a terminal identifier for the terminal 140, and/or transaction details for the transaction to manager 116. Manager 116 can maintain a savings ledger for the registered user with the information provided by agent 144.

Manager 116 sends the wallet identifier and the fiat currency amount along with the BC fee to wallet manager 114. Wallet manager 114 uses API 115 to initiate a purchase on the BC of the fiat currency amount into the user's wallet using the wallet identifier linked to the user by interacting with a third-party crypto service 153. Crypto service 153 receives the fiat currency amount from a financial account linked to cloud 110 and purchases an equivalent amount of the fiat currency amount over the BC using BC APIs 163. The BC transfer is queued on the BC to move the equivalent amount of crypto into the user's wallet.

Simultaneous to this purchase of the crypto into the user's wallet, transaction manager 143 identifies the fiat currency amount and the BC fee as a special fee, which is not to show on the transaction receipt for the user's transaction unless the user authorized this in their preferences. Agent 144 provides an instruction when providing the fiat currency amount and BC fee that informs manager 143 how the additional fees are to be handled with the transaction total for the transaction. In some cases, the crypto savings appears as a line item on a single transaction receipt printed for the user after payment is received from the user's payment time; this is scenario where the user desires no privacy with respect to the savings. In another case, manager 143 displays two separate receipts through the transaction interface to the user, one for just the transaction details and total, and one for just the crypto savings. In an embodiment, a single screen shows the transaction details along with a roundup savings amount reflecting the crypto savings; however, when the user selects print the receipt, two separate receipts are printed one for just the transaction details and one for just the savings details. In this way, when the user so desires, the savings details can be kept on separate receipts.

When the user authorizes payment that includes a transaction total and an additional crypto savings, transaction manager 143 or a separate payment manager associated with retail server 130 or terminal 140 sends the additional crypto savings amount in fiat currency to an account associated with cloud 100. It may also be that transaction system 133 maintains all transactions with fiat currency savings amounts and sends a single totaled amount at a predefined interval of time to the financial account linked to cloud 100. For example, once daily all transactions utilizing fiat currency savings amounts are transferred as a single amount from a financial account of the corresponding retailer to a financial account of cloud 100. Cloud 100 can maintain a predefined balance of fiat current in the financial account of cloud 100 for handling a day's worth or week's worth of expected transaction savings. A variety of different approaches can be processed to ensure that the funds associated with the users purchasing crypto is credited to a financial account of cloud 100 can be implemented and are intended to fall within the teachings presented herein.

In an embodiment, savings manager 116 and/or agent 144 is configured to not interrupt any transaction with crypto savings workflow when a fee percentage for purchasing the crypto relative to the roundup amount exceeds a threshold percentage. For example, when the current fee for purchasing crypto in a given transaction exceeds the roundup amount by more than 25%, then agent 144 does not attempt to obtain consent from the consumer to purchase crypto. In an embodiment, the threshold percentage is set by the consumer during a registration session or subsequently when the consumer interacts with savings manager 116 after a registration session for purposes of setting the threshold percentage or changing the threshold percentage.

In an embodiment, agent 144 initiates the purchase of a user's crypto directly using the fiat current amount and wallet identifier to interact with crypto service 153 directly. In this embodiment, details about the purchase and transaction are provided back to savings manager 116 so that manager 116 can maintain a ledger of savings on behalf of the user. It is to be noted that the user can see the crypto purchases in the BC ledger maintained on the BC for the user's wallet at any time using wallet app 124, this is independent of any ledgers maintained by savings manager 116. However, manager 116 provides additional detail in the user's savings ledger on behalf of the user, which is not available through the user's wallet ledger on the BC, such as store identifier for each savings amount, retailer name, optionally items purchased by the user during the transaction for a given savings amount, total price of a given transaction with and without the savings amount, etc.

In an embodiment, a mapping between the user's loyalty account and the user's registered wallet identifier is maintained in the loyalty system 134 of the retailer server 130. Here, registration manager 113, provides the user's wallet identifier during registration to loyalty agent 135. Agent 135 maintains the wallet identifier in the information maintained with the user's loyalty account. In this embodiment, agent 144 need not look for a reported loyalty account received by transaction manager 143 for the transaction; rather, loyalty agent identifies this and sends the wallet identifier for the user to savings agent 144. When savings agent 144 receives the wallet identifier, agent 144 contacts savings manager 116 for the user's profile information and agent 144 performs the processing discussed above with the transaction interface screen being displayed by transaction manager 143 is a payment type transaction screen.

In an embodiment, cloud 100 maintains its own crypto wallet with a variety of crypto currency types and balances. Thus, when a user wants to save by a fiat amount during a transaction, savings manager 116 interacts with wallet manager 114 and uses BC API 117 to perform a wallet-to-wallet transfer from the cloud's wallet directly to the user's wallet without using any crypto service 153 to perform the BC transfer. Wallet manager 114 can initiate purchases into the cloud's wallet utilizing crypto service 153 when it becomes necessary to do so to maintain preconfigured balances of crypto types in the cloud's wallet using a financial account associated with cloud 100 for the purchases.

In an embodiment, cloud 100 maintains custodial wallets for the users from a cloud-maintained crypto wallet. In this instance, ledgers are maintained by wallet manager 114 for each user based on their deposits through savings and any withdrawals made through other wallets maintained separately by the users through their wallet apps 124. Here, the savings amount in the fiat currency appears nearly in real time to the user via their custodial wallet through wallet app 124 and the transfer into their custodial wallet can be off-BC meaning no BC operation is needed since wallet manager 114 is just updating an internal ledger. Separately, wallet manager 114 can initiate a BC purchase into the cloud wallet through crypto service 153 using the financial account of cloud 100 to maintain proper buffers and balances in the cloud's wallet. In an embodiment, wallet app 124 is provided by cloud 100 to the user during registration and provides the user a user interface to see updated balances and the ledger maintained by savings manager 116 for their inflows and outflows for their registered wallet.

In an embodiment, the processing discussed above for cloud 110 is subsumed into a given retailer server 130. In this way, a specific retailer performs the crypto savings for registered users during each user's transaction in the manners discussed above for registration manager 113, wallet manager 114, API 115, and savings manager 116.

FIG. 1B is a diagram 100-1 depicting a registration workflow to register for cryptocurrency asset management and an example screen 120A rendered for a portion of the registration on a user-operated device 120, according to an example embodiment.

Initially, at 1, the user interacts with registration manager 113 for registration through registration interface 123. Registration interface 123 is provided through a mobile app obtained from cloud 100 and/or provided through browser pages via a browser of device 120; the pages hosted by cloud 100.

The user interacts with the user interface of registration interface 121 to provide a loyalty account, provide a wallet identifier or a wallet address, and provide user preferences, such as crypto types to purchase, roundup fiat currency amount per transaction or a roundup percentage for a any given transaction total, and privacy receipt selections. If needed or if the wallet identifier is going to be integrated into the user's loyalty account through loyalty agent 134, registration interface 121, at 2.1, interacts with loyalty system 134. Alternatively or additional, at 2.2, registration manager 113 interacts with loyalty system 134 and agent 134 to provide a wallet identifier for a any user's wallet being mapped to the user's loyalty account.

In an embodiment, the user can register more than one loyalty account associated with more than one loyalty system 134 for multiple retailers during registration. In an embodiment, registration interface 121 is provided as a mobile app that permits the user to authorize access to a camera of device 120 and snap a picture of their loyalty card or a bar code of the loyalty card such that the user does not have to manually enter any loyalty account number into an input field in a user interface of registration interface 121.

Assuming the user provides the loyalty account, screen 120A is rendered within the registration interface 123 to the user on device 120. Again, the user can manually enter their wallet address, or the registration interface may provide a scan icon next to the “enter wallet address” input fiend in screen 120A permitting the user to use a camera of device 120 and scan a quick-response (QR) code presented on another screen of another device of the user. The QR code includes the user's wallet address encoded therein. In an embodiment, registration interface 123 is subsumed into wallet app 124 when wallet app 124 is provided by cloud 100 and savings manager 116 is maintaining a newly created wallet as a custodial wallet on behalf of the user.

Assuming, the user lacks any existing crypto wallet, an option in screen 120A permits the user to activate the option for purposes of creating a wallet. This can be a custodial wallet maintained by cloud 100 or can be a wallet established by crypto service 153. When the wallet is not a custodial wallet, the registration manager 113 redirects registration interface 123 to a new user wallet creation interface screen associated with cloud service 153, once the user has a wallet created, the user returns back to screen 120A and provides the wallet address. In an embodiment, the wallet creation interface screen of crypto service 153 automatically returns back to screen 120A once a wallet is established by the user with crypto service 153. In an embodiment, API 115 provides the wallet address back to registration manager 113 once the user creates a wallet with crypto service 153.

It is noted that any order in which the registration manager 113 receives the loyalty account and wallet address can be implemented by registration manager 113. So, the loyalty account can be received first with the wallet addressed received second or vice versa.

Once a user has provided at least one loyalty account and a wallet address, registration interface 123 transitions to screen 120B for completion of the registration with registration manager 113. FIG. 1C is a diagram 100-2 of another sample screen 120B rendered on a user-operated device 120 during registration, according to an example embodiment.

Screen 120B allows the user to set a fixed about of crypto to added onto transaction totals for purposes of automatically have an equivalent amount of cryptocurrency added to the user's wallet. The illustrated fiat currency amounts are $2, $3, $5, and $10. In an embodiment, rather than fixed amounts percentages of a given transaction total is provided for selection, such as 5%, 10%, 15%, etc. In an embodiment, an option within screen 120B permits the user to toggle between selections for fixed amounts and selections for transaction total percentages.

Screen 120B also allows the user to set receipt preferences for receipts associated with transactions where crypto savings is being performed on behalf of the user through system 100. Screen 120B indicates two selections as printed copy or no printed copy with respect to the crypto savings only not with respect to the transaction receipt for a given transaction. If printed copy is set, then transaction manager 143 will print two separate receipts one for just the transaction details and one for just the crypto savings details as was discussed above. In an embodiment, a third option is provided for integration of both the transaction details and the savings details on a single printed receipt provided by transaction manager. 143.

In an embodiment, screen 120B includes a savings options that can be set to $0. This is an indication that the user desires the savings to be shut off or temporality disabled for privacy or any other reason of the user. For example, the user can know in advance that the user is going to purchase items at a retailer with someone else being present. Thus, the user wants to turn off the savings so that screen 144A by agent 144 does not appear (discussed below). In another example, the user has a particular tight month with expenses and simply wishes to disable the savings features. When the user checks the savings of $0 option, savings is turned off and agent 144 performs no savings-based processing for transactions of the user until the user deselects the $0 savings option.

FIG. 1D illustrates sample screens 100-3 rendered on a transaction terminal 140 during a transaction of a registered user, according to an example embodiment. Transaction manager 143 generates and provides screen 143A in response to the user selecting a pay option on the terminal 140 when the user is ready to pay and checkout with their goods. The transaction interface rendered by manager 143 is not modified or changed with the teachings herein; rather agent 144 detects when screen 143A has been rendered on a display of terminal 140 during the transaction.

In response to the detection of screen 143A, agent 144 renders screen 144A informing the user of the BC fee for purchasing the savings amount and asking if the user wishes to proceed by adding the pre-set savings amount to the transaction terminal before paying for the transaction at terminal 140. In an embodiment, screen 144A includes the default fiat currency amount associated with the profile of the user. In an embodiment, screen 144A includes an option to enter a user-defined amount rather than the default amount.

FIG. 1E is illustrates sample screens 100-4 rendered on the transaction terminal during a transaction, according to an example embodiment. Screen 143B is rendered to a user on a display of terminal 140 by manager 143 through the transaction interface as each item is added to the user's transaction. The example illustrates a single item of white bread, which costs $2.89, and which includes a tax of 28 cents for a transaction total of $3.17.

When the user selects the pay option in screen 143B, transaction manager through the transaction interface renders a payment type screen 143C. Agent 144 detects this screen 143 or state of the transaction and renders overlaid on top of screen 143 screen 144A of FIG. 1D. Assuming the user selected the continue option from screen 144A, screen 144A goes away and an updated screen 143C is rendered by transaction manager 143 to reflect the round up crypto savings amount in a fiat currency amount, shown as $2.00 in FIG. 1E.

Agent 144 reports the round up savings about to manager 143, causing manager 143 to update screen 143C with the roundup savings. In the example, the total moved from $3.17 to $5.17. Either agent 144 or manager 116 of cloud 100 uses the linked wallet address of the user and purchases $1.00 in crypto for the user since the current fee for the BC was shown to the user as $1.00 in screen 144A and the user selected the continue option. The crypto service 153 is contacted with the $2.00 ($1.00 of which is the fee required by service 153), a type of crypto, and a wallet address for the user's wallet. This causes the transfer of $1's worth of crypto to be purchased and transferred to the user's wallet. In an embodiment, crypto service 153 is not immediately used instead manager 116 immediately transfers an equivalent of $1.00 worth of a given crypto type from the cloud's wallet into a custodial wallet associated with the user and only engages crypto service 153 when it becomes necessary to do so to maintain a preset balance in the cloud's wallet.

FIG. 1F is a diagram 100-5 of a workflow for registering and using the cryptocurrency asset management during a transaction, according to an example embodiment. Diagram 100-5 shows a user operating a phone 120 for purposes of registering with registration manager 113 at 4. This causes a wallet address for the user to be registered and linked with the user's loyalty account at 5.

The user then engages in a transaction to purchase goods at a terminal 140 at 6. Agent 144 obtains the user profile and wallet identifier from savings manager 116 at 7. If a mapping to the user's wallet address/identifier is maintained with the loyalty account, at 8, agent 144 obtains the wallet address from loyalty system 134 using the user's loyalty account provided during the transaction by the user. At 9 agent 144 and/or manager 116 causes the crypto savings amount associated with the transaction to be purchased and transferred into the user's wallet via crypto service 153.

In an embodiment, the user performs registration through agent 144 during a transaction rather than through device 120. In this instance, agent 144 interacts with registration manager 113 and displays overlaid screens on top of the transaction interface screens that permit the user to register at which point the transaction processes as discussed above.

In an embodiment, the user can change their default amounts through registration interface 113 at any point or stop the savings altogether. Thus, the user remains in control of how much and how frequently the user is saving crypto into a wallet owned by the user. In an embodiment, registration interface 113 allows the user to change a registered wallet to a different wallet address that is preferred by the user. The user maintains complete control and the savings is private and secure through the BC with customizable receipts that mask and obscure the savings amounts for each transaction.

In an embodiment, the BC fee includes a fee assessed by cloud 100 or a retailer associated with retail server 130. In an embodiment, screen 144A shows a total fee broken down into the BC fee and the provider 100 or 130 fee.

System 100 integrates seamlessly and nearly transparently into the transaction workflow of a terminal 140. The only notifies manager 143 of any crypto savings amount. Manager 143 further provides modified receipt options as discussed above for the crypto savings.

System 100 permits users to seamlessly save during normal everyday transactions with retailers. The users save in crypto while rounding up a transaction total by a user-defined amount of percentage of the transaction total. The purchase of the savings amount is transparently processed by system 100 and privacy of the user is ensured through user-selected receipt options. The transaction terminal 140 handles fiat currency for the transaction and is completely unaware of the subsequent crypto savings transaction that occurs over the BC through system 100.

In an embodiment, terminal 120 is a self-service terminal (SST), self-checkout, automated teller machine (ATM), or a point-of-sale (POS) terminal. In the case of a cashier-assisted POS transaction, the user display presented to the user during the transaction includes the roundup crypto savings amount and the cashier display includes no reference to it other than the total amount due, which includes the roundup savings amount added to the transaction total. Alternatively, the cashier display does display the roundup savings in instances where the user is not concerned about the privacy of the savings and has authorized during registration within the user's profile.

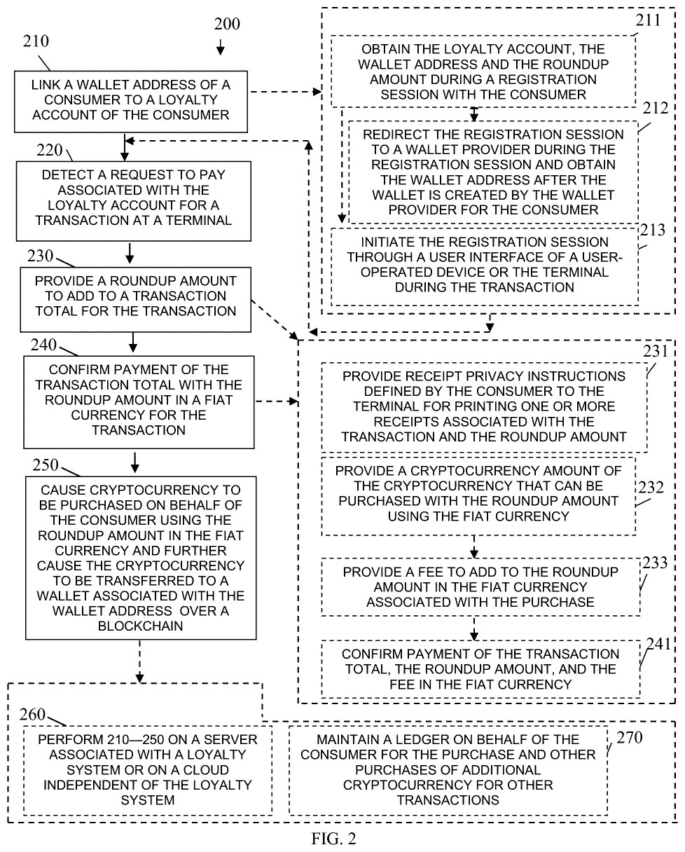

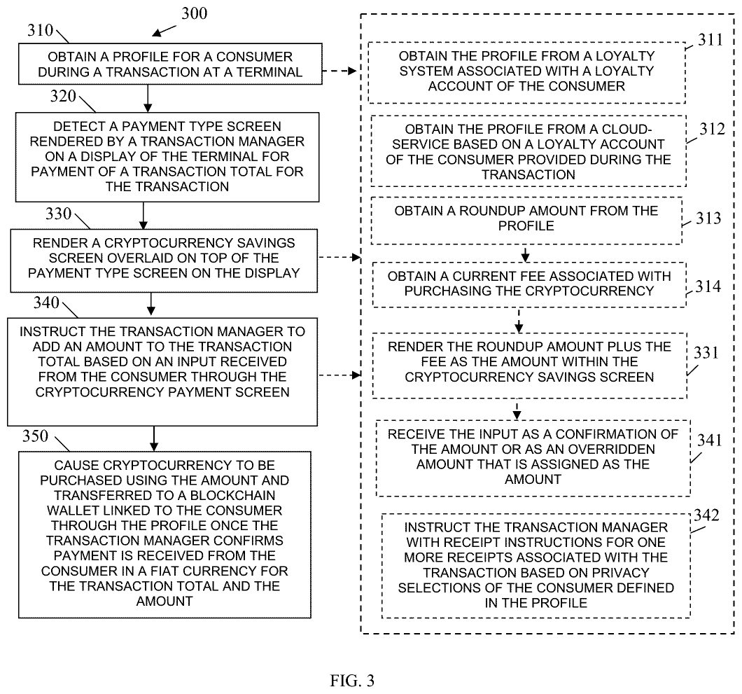

The embodiments of FIGS. 1A, 1B, 1C, 1D, 1E, 1F, and other embodiments are now discussed with reference to the FIGS. 2-3. FIG. 2 is a flow diagram of a method 200 for cryptocurrency savings during a transaction of a user, according to an example embodiment. The software module(s) that implements the method 200 is referred to as a “crypto savings manager.” The crypto savings manager is implemented as executable instructions programmed and residing within memory and/or a non-transitory computer-readable (processor-readable) storage medium and executed one or more hardware processors of one or more hardware computing devices. The processors of the devices that execute the crypto savings manager are specifically configured and programmed to process the crypto savings manager. The crypto savings manager has access to one or more networks during its processing. The networks can be wired, wireless, or a combination of wired and wireless.

In an embodiment, the device that executes the crypto savings manager is cloud 110. In an embodiment, the device that executes the crypto savings manager is retail server 130. In an embodiment, the crypto savings manager is all or some combination of 113, 114, 115, 116, 117, as discussed above with system 100.

At 210, the crypto savings manager links a wallet address/identifier of a consumer to a loyalty account of the consumer. In an embodiment, at 211, the crypto savings manager obtains the loyalty account, the wallet address, and a roundup amount during a registration session with the consumer. In an embodiment, the crypto savings manager identifies that the roundup amount is set to $0 as discussed above and which is an indication that the user has temporarily disabled crypto savings. In such a case, the crypto savings manager takes no further action and exits processing because the user does not desire to perform crypto savings during user transactions until the user accesses administrative interface 123 and makes a roundup selection amount in the user's profile that is more than $0.

In an embodiment of 211 and at 212, the crypto savings manager redirects the registration session to a wallet provider during the registration session and obtains the wallet address after a wallet is created by the wallet provider for the consumer. This is an instance where the consumer lacked a wallet before the registration was established with the consumer.

In an embodiment of 211 and at 213, the crypto savings manager initiates the registration session through a user interface of a user-operated device 120. The user interface associated with registration interface 123. In an embodiment of 211 and at 213, the crypto savings manager initiates the registration session through a user interface of a terminal 140 during a transaction; here, agent 144 provides the user interface during the transaction to the consumer.

At 220, the crypto savings manager detects a request to pay associated with the loyalty account for a transaction at a terminal 140. This is done when the $0 savings of screen 120B was not selected by the user, such that crypto savings is to be processed on behalf of the user. Agent 144 provides the loyalty account for the transaction to the crypto savings manager and the crypto savings manager links the loyalty account to the wallet address for the wallet. When the crypto savings manager determines that the $0 savings options was selected, the crypto savings manager exits processing and does not monitor the transaction since the user has temporarily shut down the crypto savings feature.

At 230, the crypto savings manager provides a roundup amount defined by the consumer to agent 144 for purposes of adding the roundup amount to a transaction total for the transaction. Assuming the consumer confirms adding the roundup amount, agent 144 reports the roundup amount to the transaction manager 143 perform transaction payment is processed by manager 143 for the transaction.

In an embodiment, at 231, the crypto savings manager provides receipt privacy instruction to agent 144 of terminal 140. The privacy instructions defined by the consumer during a registration of the consumer. The receipt privacy instructions are provided by agent 144 to transaction manager 143 for printing one or more receipts associated with the transaction and the roundup amount, as was discussed above.

In an embodiment, at 232, the crypto savings manager provides a cryptocurrency amount of the cryptocurrency that can be purchased with the roundup amount using a fiat currency. In an embodiment, crypto savings manager obtains the cryptocurrency amount via an API to a cryptocurrency service 153.

In an embodiment of 232 and at 233, the crypto savings manager provides a fee to add to the roundup amount in the fiat currency associated with purchasing the cryptocurrency over the blockchain. This fee associated with blockchain fees, a cryptocurrency service 153, and/or a fee assessed by crypto savings manager.

At 240, the crypto savings manager confirms payment of the transaction total with the roundup amount was made by the consumer in the fiat currency for transaction. For example, agent 144 reports that transaction manager 143 confirmed payment was received for the transaction. In an embodiment of 233 and 240, at 241, the crypto savings manager confirms payment of the transaction total, the roundup amount, and the fee in the fiat currency was received from the consumer.

At 250, the crypto savings manager causes cryptocurrency to be purchased on behalf of the consumer using the roundup amount in the fiat currency. The crypto savings manager also causes the cryptocurrency to be transferred to the wallet associated with the wallet address over the blockchain. In an embodiment, crypto savings manager interacts with a cryptocurrency service 153 to purchase and transfer the cryptocurrency. In an embodiment, agent 144 interacts with cryptocurrency service 153 to purchase and transfer the cryptocurrency.

In an embodiment, at 260, the crypto savings manager is processed or performs 210-250 on a server 130 associated with a loyalty system 134 or on a cloud 110 independent of loyalty system 134.

In an embodiment, at 270, the crypto savings manager maintains a savings ledger on behalf of the consumer for the purchase and for other purchases of additional cryptocurrency for other transactions of the consumer. A user interface is provided to a user-operated device 120 permitting the consumer to view the ledger on demand to keep track of savings and/or savings amount per transaction.

FIG. 3 is a flow diagram of another method 300 for cryptocurrency savings during a transaction of a user, according to an example embodiment. The software module(s) that implements the method 300 is referred to as a “crypto savings agent.” The crypto savings agent is implemented as executable instructions programmed and residing within memory and/or a non-transitory computer-readable (processor-readable) storage medium and executed by one or more hardware processors of one or more hardware devices. The processors of the devices that execute the crypto savings agent are specifically configured and programmed to process the crypto savings agent. The crypto savings agent has access to one or more networks during its processing. The networks can be wired, wireless, or a combination of wired and wireless.

The crypto savings agent interacts with the method 200. In an embodiment, the device that executes the crypto savings agent is transaction terminal 140. In an embodiment, terminal 140 is an SST, a POS terminal, an ATM, or a self-checkout terminal. In an embodiment, the crypto savings agent is all or some combination of 143 and/or 144.

At 310, the crypto savings agent obtains a profile for a consumer during a transaction at a terminal 140. In an embodiment, at 311, the crypto savings agent obtains the profile from a loyalty system 134 associated with a loyalty account of the consumer. In an embodiment, at 313, the crypto savings agent obtains the profile from a cloud-based service, such as savings manager 116, based on a loyalty account of the consumer provided during the transaction.

In an embodiment, at 313, the crypto savings agent obtains a roundup amount from the profile. In an embodiment of 313 and at 314, the crypto savings agent obtains a current fee associated with purchasing cryptocurrency at the time of the transaction.

At 320, the crypto savings agent detects a payment type screen rendered by a transaction manager 143 on a display of the terminal 140 for the transaction. Either the crypto savings agent is notified by transaction manager 143 or the crypto savings agent monitors the transaction state and transaction interface screens to detect the payment type screen rendered on a display of the terminal 140.

At 330, the crypto savings agent renders a cryptocurrency savings screen overlaid on top of the payment type screen on the display. That is, the transaction manager 144 handles the transaction workflow and the crypto savings agent handles crypto savings workflow.

In an embodiment of 314 and 330, at 331, the crypto savings agent renders the roundup amount plus the fee as the amount within the cryptocurrency screen. Thus, the consumer is notified of what portion is savings in cryptocurrency and what portion is fees.

At 340, the crypto savings agent instructs the transaction manager 143 to add an amount to the transaction total based on input received from the consumer through the cryptocurrency payment screen. In an embodiment of 331 and 340, at 341, the crypto savings agent receives the input as a confirmation of the amount or as an overridden amount that is assigned as the amount.

In an embodiment, at 342, the crypto savings agent instructs the transaction manager with receipt instructions for one or more receipts associated with the transaction based on privacy selections of the consumer. The consumer has previously defined the privacy settings within the profile during a registration session or during subsequent sessions of the consumer with savings manager 116 as was discussed above.

At 350, the crypto savings agent causes cryptocurrency to be purchased using the amount and transferred to a blockchain wallet linked to the consumer through the profile once the transaction manager 143 confirms payment is receive from the consumer in a fiat currency for the transaction total and the amount. Here, crypto savings agent can interact with cryptocurrency service 153 during a background workflow or savings manager 116 interacts with service 153 during a background workflow to cause the purchase and transfer of the cryptocurrency.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
linking a wallet address of a consumer to a loyalty account of the consumer;
detecting a request to pay associated with the loyalty account for a transaction at a terminal;
providing a roundup amount to add to a transaction total for the transaction;
confirming payment of the transaction total with the roundup amount in a fiat currency for the transaction; and
causing cryptocurrency to be purchased on behalf of the consumer using the roundup amount in the fiat currency and further causing the cryptocurrency to be transferred to a wallet associated with the wallet address over a blockchain.

2. The method of claim 1, wherein linking further includes obtaining the loyalty account, the wallet address, and the roundup amount from the consumer during a registration session with the consumer.

3. The method of claim 2, wherein obtaining further includes redirecting the registration session to a wallet provider during the registration session and obtaining the wallet address after the wallet is created by the wallet provider for the consumer.

4. The method of claim 2, wherein linking further includes initiating the registration session through a user interface of a user-operated device or the terminal during the transaction.

5. The method of claim 1, wherein providing further includes providing receipt privacy instructions defined by the consumer to the terminal for printing one or more receipts associated with the transaction and the roundup amount.

6. The method of claim 1, wherein providing further includes providing a cryptocurrency amount of the cryptocurrency that can be purchased with the with the roundup amount using the fiat currency.

7. The method of claim 6, wherein providing further includes providing a fee to add to the roundup amount in the fiat currency associated with purchasing the cryptocurrency amount.

8. The method of claim 7, wherein confirming further includes confirming payment of the transaction total, the roundup amount, and the fee in the fiat currency for the transaction.

9. The method of claim 1 further comprising, preforming the linking, the detecting, the providing, the confirming, and the causing on a server associated with a loyalty system for the loyalty account or on a cloud independent of the loyalty system.

10. The method of claim 1 further comprising, maintaining a ledger on behalf of the consumer for the purchase of the cryptocurrency during the transaction and for other purchases of additional cryptocurrency during other transactions of the consumer.

11. A method, comprising:
obtaining a profile for a consumer during a transaction at a terminal;
detecting a payment type screen rendered by a transaction manager on a display of the terminal for payment of a transaction total associated with the transaction;
rendering cryptocurrency savings screen overlaid on top of the payment type screen on the display based on the profile;
instructing the transaction manager to add an amount to the transaction total based on an input received from the consumer through the cryptocurrency payment screen; and
causing cryptocurrency to be purchased using the amount and transferred to a blockchain wallet linked to the consumer through the profile once that transaction manager confirms payment is received from the consumer in a fiat currency for the transaction total and the amount.

12. The method of claim 11, wherein obtaining further includes obtaining the profile from a loyalty system associated with a loyalty account of the consumer.

13. The method of claim 11, wherein obtaining further includes obtaining the profile from a cloud-service based on a loyalty account of the consumer provided during the transaction.

14. The method of claim 11, wherein obtaining further includes obtaining a roundup amount from the profile.

15. The method of claim 14, wherein obtaining further includes obtaining a current fee associated with purchasing the cryptocurrency.

16. The method of claim 15, wherein rendering further includes rendering the roundup amount plus the fee as the amount within the cryptocurrency savings screen.

17. The method of claim 16, wherein instructing further includes receiving the input as a confirmation of the amount or as a consumer-overridden amount that is assigned as the amount.

18. The method of claim 11, wherein instructing further includes instructing the transaction manager with receipt instructions for one or more receipts associated with the transaction based on privacy selections of the consumer defined in the profile.

19. A system comprising:
a server comprising at least one processor and a non-transitory computer-readable storage medium;
the non-transitory computer-readable storage medium comprising executable instructions;
the executable instructions when provided to or obtained by the at least one processor from the non-transitory computer-readable storage medium cause the at least one processor to perform operations, comprising:
registering a consumer for cryptocurrency savings by linking a loyalty account of the consumer to a wallet identifier for a cryptocurrency wallet of the consumer;
obtaining during the registering a profile of the consumer, wherein the profile comprises a roundup amount and receipt privacy instructions for printing one or more receipts associated with a transaction of the consumer at a terminal;
identifying the loyalty account being used during the transaction at the terminal;
obtaining a current fee associated with purchasing cryptocurrency and transferring over a blockchain to the cryptocurrency wallet;
providing the profile and the current fee to an agent on the terminal; and
causing the cryptocurrency to be purchased using a fiat currency in the roundup amount and transferred to the cryptocurrency wallet once a confirmation is received that the consumer paid for a transaction total associated with the transaction along with the roundup amount and the current fee in the fiat currency.

20. The system of claim 19, wherein the executable instructions are executed on a loyalty server as part of a loyalty system associated with the loyalty account or the executable instructions are executed on a cloud and provided as a cloud service independent of the loyalty system associated with the loyalty account.
